(19) United States
(12) Patent Application Publication
(10) Pub. No.: US 2006/0293041 A1
(43) Pub. Date: Dec. 28, 2006

(54) Reward based interface for a wireless communications device

(75) Inventor: Sangbeom Kim, Durham, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/166,932

(22) Filed: Jun. 24, 2005

(51) Int. Cl. H04M 3/00

(52) U.S. Cl. 455/418

(57) ABSTRACT

A wireless communications device includes a motion-detecting device, such as a pedometer, that generates a signal upon detecting the user's motion. Quantified characteristics of the user motion are stored in memory of the wireless communications device. The quantified characteristics represent a predetermined objective that the user desires to achieve by performing the motion. A processor receives the signal from the motion-detecting device and uses the signal to monitor selected characteristics of the user's motion. The processor compares the selected characteristics and, when the comparison indicates that the user has achieved the predetermined objective, downloads reward data to the wireless communications device.

### BACKGROUND

The present invention relates generally to wireless communications devices, and particularly to wireless communications devices equipped with motion detection devices.

Consumers often demand innovative features and new functionality when deciding on whether to purchase a particular wireless communications device. One especially popular feature allows a user to assign a melodic ring tone to a specific remote party's terminal. Upon receiving an incoming call, the user can identify the caller simply by listening to the ring tone. Also popular is the ability to play games, view images, video, and define various vibration and lighting patterns.

Consumers have come to depend a great deal on their wireless communications devices. Certainly, this dependency stems from the consumer's ability to communicate with virtually anyone anywhere in the world. However, which wireless communications device they choose may be a function of the number and/or types of features provided with the wireless communications device. Of course, consumer interest in what was once new and innovative often wanes quickly. Therefore, manufacturers consistently try to provide new features and functionality to maintain market share, and to entice consumers to purchase their product.

### SUMMARY

The present invention comprises a wireless communications device that provides a user with a reward in response to the user achieving a predetermined objective. The reward may be, for example, a complementary multimedia effect such as a melodic ring tone, screensaver, video clip, audio file, backlighting pattern, tactile function pattern, or the like. Additionally, the reward may be credits or tokens that the user may use to purchase items, application programs such as games for use on the wireless communications device, or a key used to enable functionality stored on wireless communications device. The user may receive the reward upon achieving a predetermined goal or objective stored in memory of the wireless communications device.

In one embodiment, for example, the wireless communications device includes a detector that generates a signal in response to detecting a user's motion. The detector may be internal or external to the wireless communications device. A processor receives the signal, and calculates a selected characteristic associated with the user's motion. The processor also monitors the selected characteristic, and compares the selected characteristic to a quantified characteristic stored in memory of the wireless communications device. The quantified characteristic represents a predetermined objective or goal that is associated with the motion the user is performing. When the processor determines that the user has achieved the predetermined objective, the processor executes an application program to download reward data, such as a melodic ring tone, from a remote entity.

The wireless communications device may include a transceiver to download the reward data from a remote wireless communications device via long-range or short-range interface. Additionally, the wireless communications device may download the reward data from a server via a communications network, such as a wireless communications network and/or the Internet. The wireless communications device may also be configured to delete reward data already stored in memory of the wireless communications device if the user does not achieve the predetermined objective.

### BRIEF DESCRIPTION OF THE DRAWINGS

FIG. 1 is a block diagram illustrating a wireless communications device configured according to one embodiment of the present invention.

FIG. 2 illustrates a perspective view of a wireless communications device configured according to an alternate embodiment of the present invention.

FIG. 3 illustrates a menu option that allows a user to select a target objective according to one embodiment of the present invention.

FIG. 4 is a flow diagram that illustrates a method of downloading reward data to the wireless communications device according to one embodiment of the present invention.

FIG. 5 illustrates a communications network in which a wireless communications device configured according to one embodiment of the present invention may operate.

FIG. 6 is a flow diagram that illustrates a method by which the user may download reward data to the wireless communications device according to an alternate embodiment of the present invention.

### DETAILED DESCRIPTION

The present invention comprises a wireless communications device and corresponding method that provides a user with a reward in response to the user achieving a predetermined objective. As used herein, the term “wireless communication device” may include a cellular radiotelephone, a Personal Communication System (PCS) terminal, a Personal Digital Assistant (PDA) that can include a radiotelephone, Internet/intranet access, web browser, organizer, calendar, and/or a global positioning system (GPS) receiver, a conventional laptop and/or palmtop receiver, or other appliance or mobile station that includes a radiotelephone transceiver.

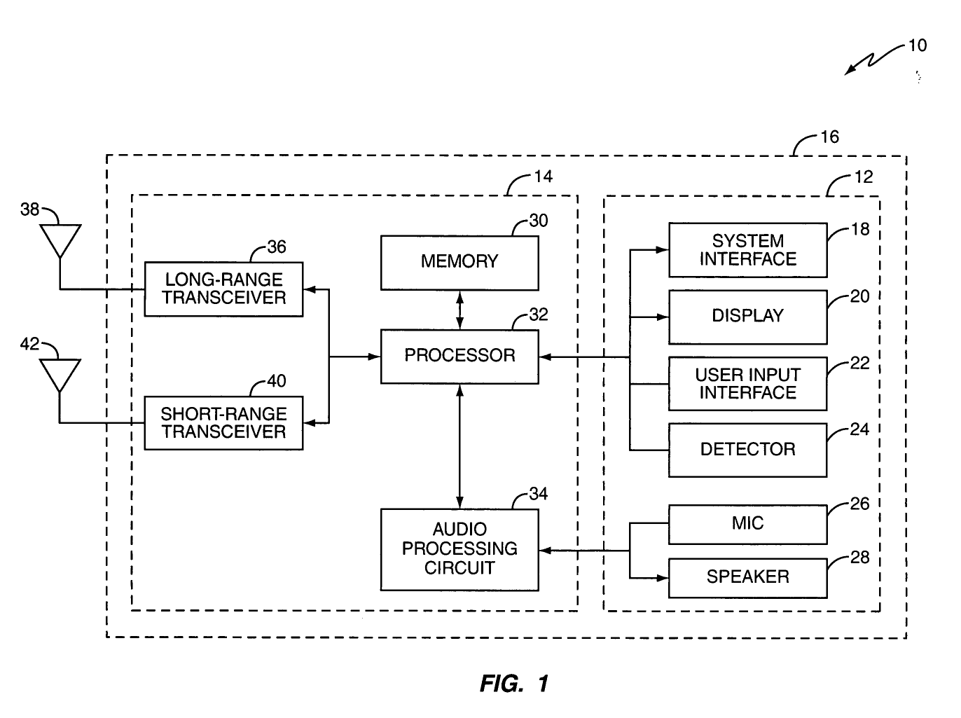

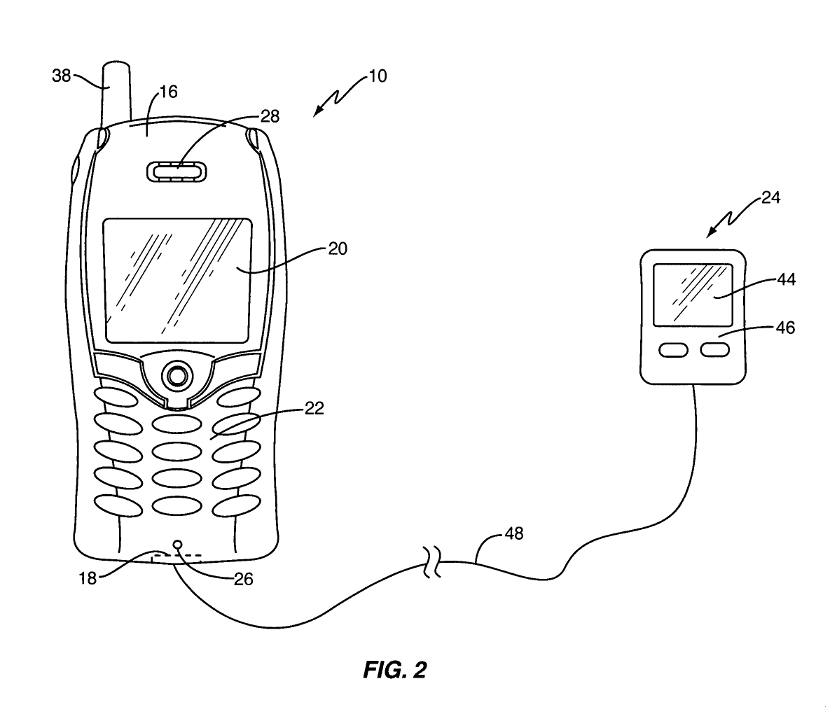

Turning now to the drawings, FIG. 1 illustrates a wireless communication device 10 configured according to one embodiment of the present invention. Wireless communication device 10 includes a user interface 12 and a communications interface 14 in a housing 16. User interface 12 includes a system interface port 18, a display 20, a user input device 22, a detector 24, a microphone 26, and a speaker 28. User interface 12 generally permits the user to interact with and control wireless communication device 10. System interface port 18 may comprise a “male” or “female” connector that allows the user to connect wireless communications device 10 with any number of desired peripheral devices. Such devices include, but are not limited to, a hands-free headset (not shown), an external camera or flash device (not shown), and an external motion detection device (FIG. 2). Display 20 allows a user to view information such as menus and menu items, dialed digits, images, call status information, output from user applications, and complementary multimedia effects, such as video clips and images downloaded as a reward to the user.

User input device 22 may include input devices such as a keypad, touchpad, joystick control dials, control buttons, and other input devices, or a combination thereof. The user input devices 22 allow the user to dial numbers, enter commands, scroll through menus and menu items presented to the user on display 20, and make selections. User input device 22 also allows the user to select and/or configure one or more predetermined target objectives stored in memory 30 of the wireless communications device. Microphone 26 receives and converts audible signals, such as the user's detected speech and other audible sound, into electrical audio signals that may be processed by audio processing circuit 34. Speaker 28 receives analog audio signals from audio processing circuit 34, and converts them into audible sound that the user can hear.

Detector 24 detects user motion. Detector 24 may be located internal to the wireless communications device 10 as seen in FIG. 1, or external to the wireless communications device 10 as seen in FIG. 2. Because detector 24 senses motion, it may require initial and/or periodic calibration by the user. For detectors internal to wireless communications device 10, the user may control and/or calibrate detector 24 using user input device 22. External detectors 24, however, may include their own display 44 and user interface 46 to allow the user to calibrate and/or control the operation of external detector 24. Additionally, for external detectors, a cable 48 may connect detector 24 to wireless communications device 10 via system interface port 18.

In one embodiment, detector 24 comprises a pedometer. As is known in the art, pedometers are motion-sensitive devices having electrical circuits that turn on and off as the user walks. Some pedometers, for example, use a magnetic pendulum that moves back and forth past a magnetic field with each step taken by the user. Other pedometers may detect the impact of the user's foot striking the ground. Regardless of how the pedometer detects the user's step, however, a digital circuit associated with the pedometer may be activated and deactivated to generate a pulse or signal that may be sent to processor 32.

Communications circuitry 14 includes, inter alia, the components necessary to allow a user to communicate with one or more remote parties via a wireless communications link. Communications circuitry 14 comprises memory 30, a processor 32, an audio processing circuit 34, a long-range transceiver 36 coupled to an antenna 38, and optionally, a short-range transceiver 40 coupled to an antenna 42. Memory 30 represents the entire hierarchy of memory in wireless communications device 10, and may include both random access memory (RAM) and read-only memory (ROM), as well as magnetic or optical disk storage. Computer program instructions and data required for operation are stored in non-volatile memory, such as EPROM, EEPROM, and/or flash memory, and may be implemented as discrete devices, stacked devices, or integrated with processor 32. As will be described in more detail later, memory 30 may store reward data provided to wireless communications device 10, and quantified characteristics associated with a motion performed by the user.

Processor 32 controls the operation of wireless communications device 10 according to programs and/or data stored in memory 30. The control functions may be implemented in a single microprocessor, or in multiple microprocessors. Suitable processors may include, for example, both general purpose and special purpose microprocessors. Processor 30 may interface with audio processing circuit 34, which provides basic analog output signals to speaker 28 and receives analog audio inputs from microphone 26. In addition, processor 32 may also receive the signals generated by detector 24, and use the signals to determine when the user achieves a predetermined objective. Based on the determination, processor 32 may control wireless communications device 10 to download reward data to or delete reward data from memory 30. Additionally, processor 32 may be configured to unlock and/or lock reward data such that the reward data is enabled or disabled for use by the user.

Long-range transceiver 36 and antenna 38 allow a user to communicate wireless speech and data signals to and from a base station in a wireless communications network. Long-range transceiver 36 may be a fully functional cellular radio transceiver that operates according to any known standard, including the standards known generally as the Global System for Mobile Communications (GSM), TIA/EIA-136, cdmaOne, cdma2000, UMTS, and Wideband CDMA. In addition, long-range transceiver 36 may include baseband-processing circuits to process the transmitted and received signals. Alternatively, however, baseband-processing circuits may be incorporated in processor 32.

Short-range transceiver 40 and antenna 42 allow a user to communicate wireless signals to and from a corresponding short-range transceiver (not shown). In one embodiment, short-range transceiver 40 is a BLUETOOTH transceiver or RF transceiver operating according to the IEEE 802.11(b) or 802.11(g) standards. As is well known in the art, BLUETOOTH is a universal radio interface that permits the creation of ad hoc networks, and is particularly well-suited for communications over short distances. It should be understood, however, that short-range transceiver 40 may utilize any technology known in the art operable to transmit and receive signals over short distances, for example, infra-red, and hardwired cables.

According to the present invention, the user may obtain or lose reward data for use with wireless communications device 10 based on whether the user achieves a predetermined objective. Particularly, processor 32 may receive the signals generated by detector 24, and translate the signals using well-known mathematical techniques into various pieces of information or “characteristics” of the motion performed by the user. In embodiments where detector 24 comprises a pedometer, for example, the “characteristics” may be the number of steps the user takes, the number of calories the user burns while walking, the distance the user travels, the average velocity of the user while walking, or any combination thereof. Processor 32 may also determine other characteristics from the generated signals in lieu of or in addition to those stated above. Processor 32 may compare these characteristics to corresponding target objectives for the user.

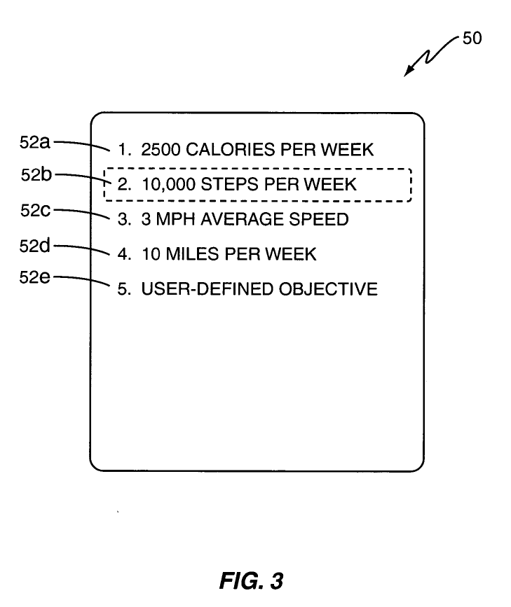

FIG. 3 illustrates some exemplary predetermined objectives, and how the user might select or define a predetermined target objective according to one embodiment of the present invention. Particularly, wireless communications device 10 may display a menu 50 that allows the user to select one or more target objectives 52a-52d pre-stored in memory 30. In addition, the user may set one or more user-defined objectives 52e. The predetermined objectives 52a-52e define, in this embodiment, quantified characteristics that the user must achieve to receive the reward. As seen in FIG. 3, the quantified characteristics may be time-qualified such that the user must achieve the predetermined objective within a specified time. Based on whether the user achieves the objective, reward data may be downloaded to or uploaded from the user's wireless communications device 10.

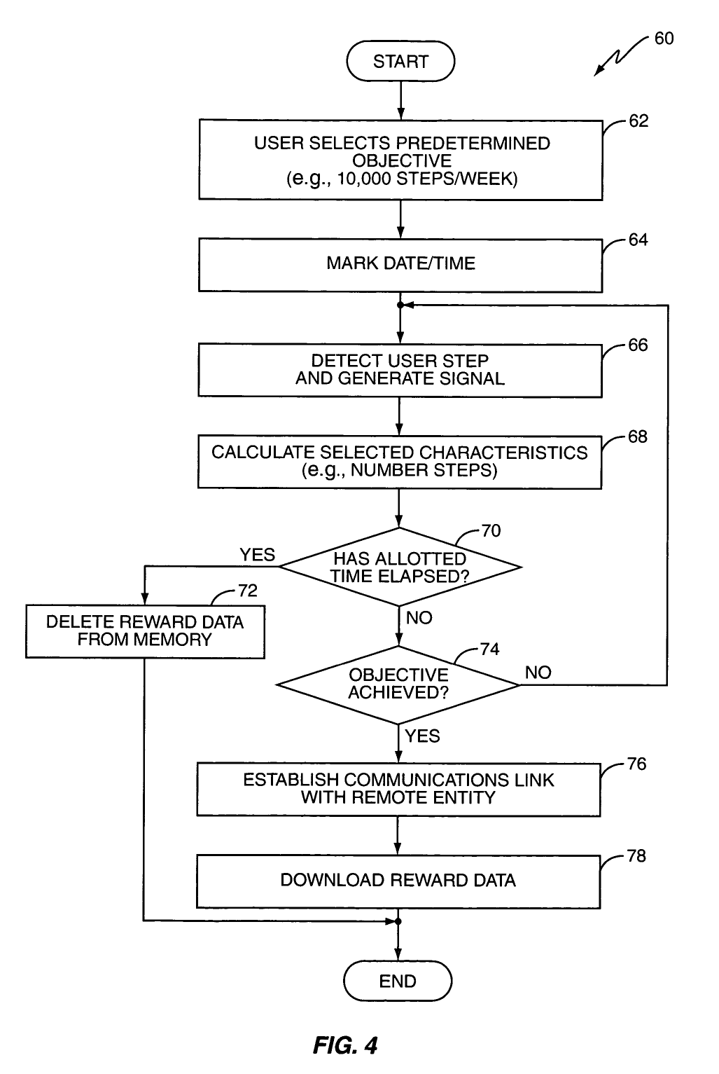

FIG. 4 illustrates a method 60 by which reward data may be provided to wireless communications device 10 according to one embodiment of the present invention. As previously described, the user selects a predetermined objective to achieve from menu 50 (box 62). The predetermined objective may be selected from a menu, or user-defined. For illustrative purposes only, method 60 assumes that the user has selected option 52b, which requires the user to walk 10,000 steps within a week. However, the user may select other options in lieu of or in addition to selected option 52b. For time-qualified objectives, processor 32 may note the start date and time, or alternatively, start a timer that expires when the specified time has elapsed (box 64).

In use, the user walks with the wireless communications device 10 on his or her body. Detector 30 generates a signal for each step that is detected (box 66). Processor 32 receives the signal generated by detector 30, and calculates a selected characteristic using well-known mathematical techniques (box 68). For example, the generated signal in this embodiment comprises an electrical pulse that corresponds to a step taken by the user. Upon receipt of the signal, processor 32 may increment a counter in memory 30 to monitor the accumulated number of steps over time. Likewise, processor 32 may calculate and maintain variables for the number of calories burned by the user, the distance traveled, average velocity of the user, or other characteristics.

Processor 32 may check to determine whether the time specified in the selected objective (e.g., one week) has elapsed (box 70). If the specified time has elapsed without the user having walked the specified number of steps (e.g., 10,000), processor 32 may determine that the user has failed to achieve the predetermined objective within the specified time frame. In these cases, processor 32 may delete a reward already stored in memory 30 (box 72). If the specified time has not elapsed (box 70), processor 32 may compare the accumulated number of steps to the total number of steps specified by the objective (box 82). If processor 32 determines that the accumulated number of steps is less than the total number of steps specified in the selected objective, the process continues with detector 30 generating the signal for the next detected step (box 66). Otherwise, processor 32 may determine that the user has taken the total number of steps needed to achieve the objective (box 74). Processor 32 may than establish a communications link with a remote entity (box 76), and download the reward data to memory 30 of the wireless communications device 10 (box 78).

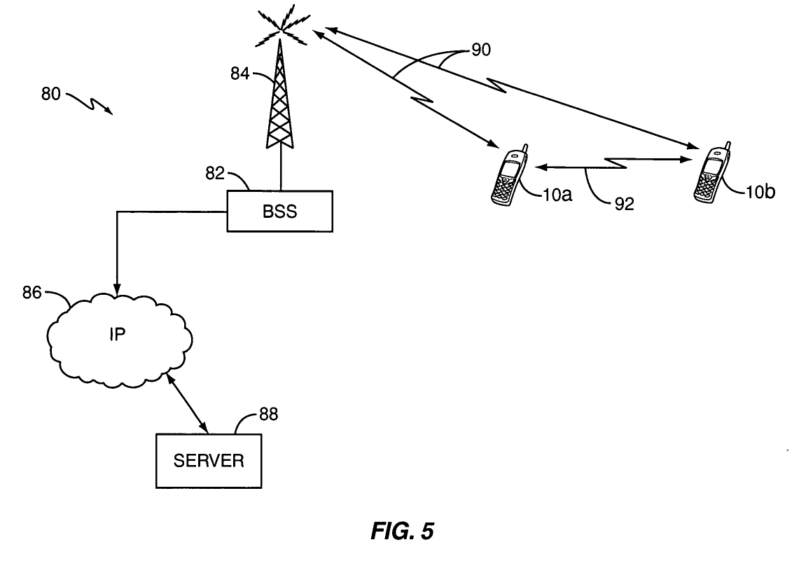

In one embodiment, wireless communications device 10 may download the reward data from the remote entity over a communications network 80 as seen in FIG. 5. Network 80 comprises a Base Station Subsystem (BSS) 82 connected to an antenna 84. BSS 82 provides wireless communications devices 10a, 10b over air interface links 90 with services that allow devices 10a, 10b to communicate with each other, and with other remote parties. In addition, BSS 82 may also provide a communications path to a server 88 via a public or private IP network. In some embodiments of the present invention, reward data is stored on server 88. When processor 32 determines that the user has obtained the predetermined objective, it may generate a request for the reward data to server 88. The request may include information that identifies, inter alia, the user, the reward data requested, and the objective achieved by the user. Upon receipt of the request, server 88 may download the reward data to the requesting wireless communications device 10 over the air interface 90. Likewise, if the user fails to achieve the objective, processor 32 may generate a message for transmission to server 88 informing the server 88 that the user has lost a specific reward.

In another embodiment, one user of a wireless communications device 10a might compete against another user of a wireless communications device 10b. At stake could be reward data stored already stored on one or both devices 10a, 10b. For example, the competition might be that the first person to burn 2500 calories walking wins reward data stored on the other's device. The loser would, of course, lose the specified reward data by having it deleted from memory 30. The users may register their competition objectives and the reward data with server 88. Upon reaching the objective, the processor 32 of the “winning” wireless communications device 10a may generate a message to server 88 requesting the download. Server 88 may then generate a message to the “losing” party's device 10b to download the wagered-for reward data to the “winning” party's device 10a, and to delete the reward data from memory 30 of the wireless communications device 10b.

In an alternate embodiment, wireless communications devices 10a, 10b could exchange the wagered-for reward data over a short-range communications link 92 established between the devices. In this embodiment, both wireless communications device may include short-range transceivers 40. The processor 32 of the winning device 10a could generate a request for the reward data to server 88. Server 88 could than transmit a message to wireless communications device 10b controlling it to transmit the reward data over the short-range link 92 and to delete the lost reward data from its memory 30. Of course, those skilled in the art will appreciate that processors 32 of the respective wireless communications devices 10a, 10b can be configured to exchange the reward data over the short-range link 92 without interaction with server 88.

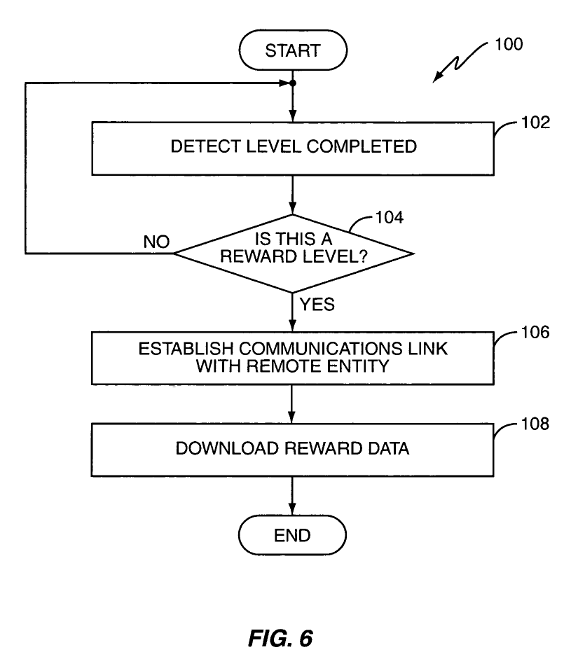

Thus, users may obtain reward data for successfully completing a predetermined objective, and may lose reward data for failing to complete a predetermined objective. The predetermined objective thus far has been described in terms of a physical activity (e.g., walking) performed by the user. In addition, however, users may be able to achieve reward data for other activities, such as successfully completing levels of a game application stored on wireless communications device 10. As seen in FIG. 6, for example, a method 100 illustrates how a user might obtain additional levels of a game responsive to processor 32 detecting when the user has successfully completed a specified level.

Particularly, the game application may be executed on processor 32, and thus, processor 32 may detect each time the user completes a level (box 102). Processor 32 may determine if the completed level is a level at which the user obtains a reward (box 104). If not, processor 32 establishes a communications link (box 106), and downloads the reward data (box 108). The reward data may be, for example, the next level or levels of the game that the user is currently playing. Thus, users would not be limited to only those games that will fit into memory 30. That is, memory 30 would only have to store a few levels of the game at a time, for example, 3 levels. Whenever the user completes the levels stored in memory 30, the next three levels could be downloaded to replace the levels already in memory 30.

The reward data may be any type of data or information. However, in one embodiment, the reward data comprises a complementary multimedia effect that may be executed by wireless communications device 10. For example, the reward data may be a video clip, an image, audio files, a melodic ring tone, a screensaver, a game, tactile vibration pattern, backlighting pattern, or the like. In other embodiments, the reward data comprises tokens or credits that the user may employ to make an electronic purchase with wireless communications device 10. In some embodiments, the reward data may comprise a key that permits the user receiving the reward to unlock some functionality. Whatever the reward data, it may be stored in memory 30 for later use by wireless communications device 10. In addition, the reward data received by wireless communications device 10 when the user achieves the objective may be randomly selected, or may be tied to the difficulty of the predetermined objective. For example, a more difficult-to-achieve objective may be rewarded with data having a greater value than a less difficult-to-achieve objective. Further, successive achievements may result in downloading reward data of a successively increasing value.

The description so far has described the present invention in terms of the processor 32 calculating the characteristics based on the signals received from the detector 24. However, the present invention is not so limited. Alternatively, detector 24 may comprise the circuitry to perform the calculations, and simply provide processor 32 with one or more signals indicative of the calculated characteristics. In these cases, processor 32 may simply receive the signals and update corresponding variables in memory as needed or desired to monitor the characteristics.

Additionally, wireless communications device 10 need not interact with server 88 to exchange reward data with another wireless communications device 10. In one embodiment, two users performing some activity, such as playing a sport, can “wager” reward data stored on their respective devices. One or both of the users could manually enter the final score into their wireless communications devices 10. The reward data could be “won” or “lost” based on the final score, and exchanged between devices via a short-range communications link.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of providing a user of a wireless communications device with reward-based feedback, the method comprising:
generating a signal responsive to detecting a user's motion;
comparing a selected characteristic of the user's motion to a quantified characteristic of the user's motion, wherein the quantified characteristic represents a predetermined objective of the user performing the motion; and
downloading reward data to the wireless communications device when the comparison indicates that the user has achieved the predetermined objective.

2. The method of claim 1 further comprising monitoring the selected characteristic of the user's motion responsive to the generated signal.

3. The method of claim 2 further comprising deleting the reward data from memory of the wireless communications device when the comparison indicates that the user has not achieved the predetermined goal.

4. The method of claim 2 wherein monitoring the selected characteristic comprises maintaining a value representing the selected characteristic, and updating the value responsive to successively received signals.

5. The method of claim 4 wherein the user has achieved the predetermined objective if the value is equal to or greater than a value indicative of the quantified characteristic.

6. The method of claim 1 wherein the quantified characteristic is time-bound, and downloading the reward data comprises downloading the reward data when the comparison indicates that the user has achieved the predetermined objective within an allotted time.

7. The method of claim 1 further comprising providing one or more predetermined objectives from which the user may select the predetermined objective.

8. The method of claim 1 further comprising receiving user input indicating a result of a competitive activity performed by the user.

9. The method of claim 8 further comprising downloading the reward data based the user input.

10. The method of claim 1 further comprising establishing a communications link with a remote wireless communications device to download the reward data from the remote wireless communications device.

11. The method of claim 1 further comprising establishing a communications link with a server via a wireless communications network to download the reward data from the server.

12. The method of claim 1 wherein generating the signal comprises generating the signal responsive to detecting a step taken by the user.

13. The method of claim 12 wherein the selected characteristic and the quantified characteristic are associated with the number of steps the user takes.

14. The method of claim 13 wherein downloading the reward data is based on the total number of steps taken by the user.

15. A wireless communications device comprising:
a transceiver operative to transmit and receive wireless communications signals;
a motion detector operative to generate a signal responsive to a detected user motion;
memory operative to store a quantified characteristic of the user motion that represents a predetermined objective of the user performing the detected motion; and
a processor configured to:
monitor a selected characteristic of the user motion responsive to the signal from the motion detector; and
download reward data via the transceiver when a comparison of the selected characteristic and the quantified characteristic indicates that the user has achieved the predetermined objective.

16. The wireless communications device of claim 15 wherein the processor is further configured to delete the reward data when the comparison indicates that the user has not achieved the predetermined objective.

17. The wireless communications device of claim 15 wherein the processor is configured to download the reward data from a remote wireless communications device.

18. The wireless communications device of claim 15 wherein the processor is configured to download the reward data from a server via a wireless communications network.

19. The wireless communications device of claim 15 wherein the motion detector comprises a pedometer that generates the signal responsive to detecting a step taken by the user.

20. The wireless communications device of claim 19 wherein the processor is configured to calculate the selected characteristic upon receiving the signal from the motion detector.

21. The wireless communications device of claim 20 wherein the selected characteristic includes information selected from the group consisting of: the number of steps the user takes, a number of calories the user burns, a velocity of the user, and a distance traversed by the user.

22. The wireless communications device of claim 21 wherein the quantified characteristic of the user motion includes information selected from the group consisting of: a predetermined number of steps, a predetermined number of calories to burn, a predetermined velocity, and a predetermined distance.

23. The wireless communications device of claim 15 wherein the reward data comprises a complementary multimedia effect that may be executed by the processor.

24. The wireless communications device of claim 15 wherein the reward data comprises one or more tokens that may be used to make an electronic purchase with the wireless communications device.

25. The wireless communications device of claim 15 wherein the reward data comprises an application that may be executed by the processor.

26. The wireless communications device of claim 1 wherein the reward data comprises a key that is used to enable the reward data.

27. The wireless communications device of claim 15 further comprising a user interface operative to receive user input indicating a result of a competitive activity performed by the user.

28. The wireless communications device of claim 27 wherein the processor is configured to download the reward data responsive to the user input.

29. The wireless communications device of claim 27 wherein the processor is configured to delete the reward data from memory responsive to the user input.
